(19) United States
(12) Patent Application Publication
(10) Pub. No.: US 2026/0214263 A1
(43) Pub. Date: Jul. 23, 2026

(54) Method and Apparatus of Parameters Inheritance for Overlapped Blocks Motion Compensation in Video Coding System

(71) Applicant: MEDIATEK INC., Hsinchu City (TW)

(72) Inventors: Yu-Cheng LIN, Hsinchu City (TW); Tzu-Der CHUANG, Hsinchu City (TW); Chih-Wei HSU, Hsinchu City (TW); Ching-Yeh CHEN, Hsinchu City (TW); Yi-Wen CHEN, San Jose, CA (US); Yu-Wen HUANG, Hsinchu City (TW)

(21) Appl. No.: 19/141,217

(22) PCT Filed: Dec. 19, 2023
(86) PCT No.: PCT/CN2023/139961

§ 371 Date: Jun. 19, 2025

Related U.S. Application Data
(60) Provisional application No. 63/478,201, filed on Jan. 3, 2023.
(60) Provisional application No. 63/479,755, filed on Jan. 13, 2023.
(60) Provisional application No. 63/488,204, filed on Mar. 3, 2023.
(60) Provisional application No. 63/513,129, filed on Jul. 12, 2023.

(51) Int. Cl. H04N 19/583; H04N 19/176; H04N 19/52

(52) U.S. Cl. CPC H04N 19/583; H04N 19/176; H04N 19/52

(57) ABSTRACT

A method and apparatus for video coding using Overlapped Block Motion Compensation (OBMC). According to this method, one or more parameters associated with one or more coding tools applied to the neighbouring block, the neighbouring subblock, the current block, the current subblock or a combination thereof are determined, where at least one of said one or more parameters is inherited from the neighbouring block, the neighbouring subblock, the current block, the current subblock or the combination thereof. OBMC process is applied to at least one boundary of the current block, the current subblock, the neighbouring block and the neighbouring subblock according to OBMC parameters comprising said at least one of said one or more parameters.

### CROSS REFERENCE TO RELATED APPLICATIONS

The present invention is a non-Provisional Application of and claims priority to U.S. Provisional Patent Application No. 63/478,201, filed on Jan. 3, 2023, U.S. Provisional Patent Application No. 63/479,755, filed on Jan. 13, 2023, U.S. Provisional Patent Application No. 63/488,204, filed on Mar. 3, 2023 and U.S. Provisional Patent Application No. 63/513,129, filed on Jul. 12, 2023. The U.S. Provisional Patent Application is hereby incorporated by reference in its entirety.

### FIELD OF THE INVENTION

The present invention relates to video coding system. In particular, the present invention relates to Overlapped Block Motion Compensation (OBMC) using parameters inherited from the current block and/or neighbouring block.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Furthermore, various new coding tools have been proposed for consideration in the development of a new coding standard beyond the VVC. Among various new coding tools, some coding tools relevant to the present invention are reviewed as follows.

### Overlapped Block Motion Compensation (OBMC)

Overlapped Block Motion Compensation (OBMC) is to find a Linear Minimum Mean Squared Error (LMMSE) estimate of a pixel intensity value based on motion-compensated signals derived from its nearby block motion vectors (MVs). From estimation-theoretic perspective, these MVs are regarded as different plausible hypotheses for its true motion, and to maximize coding efficiency, their weights should minimize the mean squared prediction error subject to the unit-gain constraint.

When High Efficient Video Coding (HEVC) was developed, several proposals were made using OBMC to provide coding gain. Some of them are described as follows.

In JCTVC-C251 (Peisong Chen, et. al., “Overlapped block motion compensation in TMuC”, Joint Collaborative Team on Video Coding (JCT-VC) of ITU-T SG16 WP3 and ISO/IEC JTC1/SC29/WG11, 3rd Meeting: Guangzhou, CN, 7-15 Oct. 2010, Document: JCTVC-C251), OBMC was applied to geometry partition. In geometry partition, it is very likely that a transform block contains pixels belonging to different partitions. In geometry partition, since two different motion vectors are used for motion compensation, the pixels at the partition boundary may have large discontinuities that can produce visual artefacts similar to blockiness. This in turn decreases the transform efficiency. Let the two regions created by a geometry partition be denoted by region 1 and region 2. A pixel from region 1 (2) is defined to be a boundary pixel if any of its four connected neighbours (left, top, right, and bottom) belongs to region 2 (1). FIG. 2 shows an example where grey-dotted pixels belong to the boundary of region 1 (grey region) and white-dotted pixels belong to the boundary of region 2 (white region). If a pixel is a boundary pixel, the motion compensation is performed using a weighted sum of the motion predictions from the two motion vectors. The weights are ¾ for the prediction using the motion vector of the region containing the boundary pixel and ¼ for the prediction using the motion vector of the other region. The overlapping boundaries improve the visual quality of the reconstructed video while also providing BD-rate gain.

In JCTVC-F299 (Liwei Guo, et. al., “CE2: Overlapped Block Motion Compensation for 2N×N and N×2N Motion Partitions”, Joint Collaborative Team on Video Coding (JCT-VC) of ITU-T SG16 WP3 and ISO/IEC JTC1/SC29/WG11, 6th Meeting: Torino, 14-22 Jul. 2011, Document: JCTVC-F299), OBMC was applied to symmetrical motion partitions. If a coding unit (CU) is partitioned into 2 2N×N or N×2N prediction units (PUs), OBMC is applied to the horizontal boundary of the two 2N×N prediction blocks, and the vertical boundary of the two N×2N prediction blocks. Since those partitions may have different motion vectors, the pixels at partition boundaries may have large discontinuities, which may generate visual artefacts and also reduce the transform/coding efficiency. In JCTVC-F299, OBMC is introduced to smooth the boundaries of motion partition.

FIGS. 3A-B illustrate an example of OBMC for 2N×N (FIG. 3A) and N×2N blocks (FIG. 3B). The grey pixels are pixels belonging to Partition 0 and white pixels are pixels belonging to Partition 1. The overlapped region in the luma component is defined as 2 rows (columns) of pixels on each side of the horizontal (vertical) boundary. For pixels which are 1 row (column) apart from the partition boundary, i.e., pixels labelled as A in FIGS. 3A-B, OBMC weighting factors are (¾, ¼). For pixels which are 2 rows (columns) apart from the partition boundary, i.e., pixels labelled as B in FIGS. 3A-B, OBMC weighting factors are (⅞, ⅛). For chroma components, the overlapped region is defined as 1 row (column) of pixels on each side of the horizontal (vertical) boundary, and the weighting factors are (¾, ¼).

Currently, the OBMC is performed after normal MC, and BIO is also applied in these two MC processes, separately. That is, the MC results for the overlapped region between two CUs or PUs is generated by another process not in the normal MC process. BIO (Bi-Directional Optical Flow) is then applied to refine these two MC results. This can help to skip the redundant OBMC and BIO processes, when two neighbouring MVs are the same. However, the required bandwidth and MC operations for the overlapped region is increased compared to integrating OBMC process into the normal MC process. For example, the current PU size is 16×8, the overlapped region is 16×2, and the interpolation filter in MC is 8-tap. If the OBMC is performed after normal MC, then we need (16+7)×(8+7)+(16+7)×(2+7)=552 reference pixels per reference list for the current PU and the related OBMC. If the OBMC operations are combined with normal MC into one stage, then only (16+7)×(8+2+7)=391 reference pixels per reference list for the current PU and the related OBMC. Therefore, in the following, in order to reduce the computation complexity or memory bandwidth of BIO, several methods are proposed, when BIO and OBMC are enabled simultaneously.

In the JEM (Joint Exploration Model), the OBMC is also applied. In the JEM, unlike in H.263, OBMC can be switched on and off using syntax at the CU level. When OBMC is used in the JEM, the OBMC is performed for all motion compensation (MC) block boundaries except for the right and bottom boundaries of a CU. Moreover, it is applied to both the luma and chroma components. In the JEM, a MC block corresponds to a coding block. When a CU is coded with sub-CU mode (includes sub-CU merge, affine and FRUC mode), each sub-block of the CU is a MC block. To process CU boundaries in a uniform fashion, OBMC is performed at sub-block level for all MC block boundaries, where sub-block size is set equal to 4×4, as illustrated in FIGS. 4A-B.

When OBMC is applied to the current sub-block, besides current motion vectors, motion vectors of four connected neighbouring sub-blocks, if available and are not identical to the current motion vector, are also used to derive the prediction block for the current sub-block. These multiple prediction blocks based on multiple motion vectors are combined to generate the final prediction signal of the current sub-block. Prediction block based on motion vectors of a neighbouring sub-block is denoted as PNn, with n indicating an index for the neighbouring above, below, left and right sub-blocks and prediction block based on motion vectors of the current sub-block is denoted as PC. FIG. 4A illustrates an example of OBMC for sub-blocks of the current CU 410 using a neighbouring above sub-block (i.e., PN1), left neighbouring sub-block (i.e., PN2), left and above sub-blocks i.e., PN3). FIG. 4B illustrates an example of OBMC for the ATMVP mode, where block PN uses MVs from four neighbouring sub-blocks for OBMC. When PN is based on the motion information of a neighbouring sub-block that contains the same motion information as the current sub-block, the OBMC is not performed from PN. Otherwise, every sample of PN is added to the same sample in PC, i.e., four rows/columns of PN are added to PC. The weighting factors {¼, ⅛, 1/16, 1/32} are used for PN and the weighting factors {¾, ⅞, 15/16, 31/32} are used for PC. The exception are small MC blocks (i.e., when height or width of the coding block is equal to 4 or a CU is coded with sub-CU mode), for which only two rows/columns of PN are added to PC. In this case, weighting factors {¼, ⅛} are used for PN and weighting factors {¾, ⅞} are used for PC. For PN generated based on motion vectors of vertically (horizontally) neighbouring sub-block, samples in the same row (column) of PN are added to PC with a same weighting factor.

In the JEM, for a CU with size less than or equal to 256 luma samples, a CU level flag is signalled to indicate whether OBMC is applied or not for the current CU. For the CUs with size larger than 256 luma samples or not coded with the AMVP mode, OBMC is applied by default. At the encoder, when OBMC is applied for a CU, its impact is taken into account during the motion estimation stage. The prediction signal formed by OBMC using motion information of the top neighbouring block and the left neighbouring block is used to compensate the top and left boundaries of the original signal of the current CU, and then the normal motion estimation process is applied.

In JEM (Joint Exploration Model for VVC development), the OBMC is applied. For example, as shown in FIG. 5, for a current block 510, if the above block and the left block are coded in an inter mode, it takes the MV of the above block to generate an OBMC block A and takes the MV of the left block to generate an OBMC block L. The predictors of OBMC block A and OBMC block L are blended with the current predictors. To reduce the memory bandwidth of OBMC, it is proposed to do the above 4-row MC and left 4-column MC with the neighbouring blocks. For example, when doing the above block MC, 4 additional rows are fetched to generate a block of (above block+OBMC block A). The predictors of OBMC block A are stored in a buffer for coding the current block. When doing the left block MC, 4 additional columns are fetched to generate a block of (left block+OBMC block L). The predictors of OBMC block L are stored in a buffer for coding the current block. Therefore, when doing the MC of the current block, four additional rows and four additional columns of reference pixels are fetched to generate the predictors of the current block, the OBMC block B, and the OBMC block R as shown in FIG. 6A (may also generate the OBMC block BR as shown in FIG. 6B). The OBMC block B and the OBMC block R are stored in buffers for the OBMC process of the bottom neighbouring blocks and the right neighbouring blocks.

For an M×N block, if the MV is not integer and a 8-tap interpolation filter is applied, a reference block with size of (M+7)×(N+7) is used for motion compensation. However, if the BIO and OBMC is applied, additional reference pixels are required, which increases the worst case memory bandwidth.

In VVC and the next generation video coding standard development, various newer coding tools to improve coding efficiency have been disclosed. The coding tools relevant to the present invention are briefly reviewed as follows.

### Local Illumination Compensation (LIC)

Local Illumination Compensation (LIC) is a method of inter prediction by using neighbouring samples of current block and reference block. It is based on a linear model using a scaling factor a and an offset b. It derives the scaling factor a and the offset b by referring to the neighbouring samples of current block and reference block. Moreover, the coding tool is enabled or disabled adaptively for each CU.

For more detail for LIC, it can refer to the document “JVET-C1001 (J. Chen, et al., “Algorithm Description of Joint Exploration Test Model 3”, Joint Video Exploration Team (JVET) of ITU-T SG 16 WP 3 and ISO/IEC JTC 1/SC 29/WG 11, 3rd Meeting: Geneva, CH, 26 May-1 June 2016, document JVET-C1001).

Bi-Prediction with CU-Level Weight (BCW)

In HEVC, the bi-prediction signal, P_{bi-pred} is generated by averaging two prediction signals, P₀ and P₁ obtained from two different reference pictures and/or using two different motion vectors. In VVC, the bi-prediction mode is extended beyond simple averaging to allow weighted averaging of the two prediction signals.

$${P}_{b i - p r e d} = ( ( 8 - w ) * {P}_{0} + w * {P}_{1} + 4 ) >> 3$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used. At the encoder, fast search algorithms are applied to find the weight index without significantly increasing the encoder complexity. These algorithms are summarized as follows. The details are disclosed in the VTM software and document JVET-L0646 (Yu-Chi Su, et. al., “CE4-related: Generalized bi-prediction improvements combined from JVET-L0197 and JVET-L0296”, Joint Video Experts Team (JVET) of ITU-T SG 16 WP 3 and ISO/IEC JTC 1/SC 29, 12th Meeting: Macao, CN, 3-12 Oct. 2018, Document: JVET-L0646).

### Decoder-Side Motion Vector Refinement (DMVR)

In JVET-D0029 (Xu Chen, et al., “Decoder-Side Motion Vector Refinement Based on Bilateral Template Matching”, in Joint Video Exploration Team (JVET) of ITU-T SG 16 WP 3 and ISO/IEC JTC 1/SC 29/WG 11, 4th Meeting: Chengdu, CN, 15-21 Oct. 2016, Document: JVET-D0029), Decoder-Side Motion Vector Refinement (DMVR) based on bilateral template matching is disclosed. A template is generated by using the bi-prediction from the reference blocks of two motion vectors respectively. The template is used as a new current block and the motion estimation is performed to find a better matching block in Ref. Picture 0 and Ref. Picture 1, respectively. The two motion vectors are then refined, and the refined motion vectors are used to generate a final bi-predicted prediction block for the current block.

### Bi-Directional Optical Flow (BDOF)

BDOF (also referred as Bi-directional Optical flow (BIO)) is motion estimation/compensation technique disclosed in JCTVC-C204 (E. Alshina, et al., Bi-directional optical flow, Joint Collaborative Team on Video Coding (JCT-VC) of ITU-T SG 16 WP 3 and ISO/IEC JTC 1/SC 29/WG 11, 3rd Meeting: Guangzhou, CN, 7-15 Oct. 2010, Document: JCTVC-C204) and VCEG-AZ05 (E. Alshina, et al., Known tools performance investigation for next generation video coding, ITU-T SG 16 Question 6, Video Coding Experts Group (VCEG), 52^{nd} Meeting: 19-26 Jun. 2015, Warsaw, Poland, Document: VCEG-AZ05). BIO derived the sample-level motion refinement based on the assumptions of optical flow and steady motion It is applied only for truly bi-directional predicted blocks, which is predicted from two reference pictures corresponding to the previous picture and the latter picture. In VCEG-AZ05, BIO utilizes a 5×5 window to derive the motion refinement of each sample. Therefore, for an N×N block, the motion compensated results and corresponding gradient information of an (N+4)×(N+4) block are required to derive the sample-based motion refinement for the N×N block. According to VCEG-AZ05, a 6-Tap gradient filter and a 6-Tap interpolation filter are used to generate the gradient information for BIO.

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m,n∈{3 . . . 6} excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions, where the partitions are grouped according to their angles. Each part of a geometric partition in the CU is inter-predicted using its own motion; only uni-prediction is allowed for each partition, that is, each part has one motion vector and one reference index.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks of current CU.

Merge Mode with MVD (MMVD)

In addition to merge mode, where the implicitly derived motion information is directly used for prediction samples generation of the current CU, the merge mode with motion vector differences (MMVD) is introduced in VVC. An MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one of the first two candidates in the merge list is selected to be used as MV basis. The MMVD candidate flag is signalled to specify which one is used between the first and second merge candidates.

### Motion Compensated Boundary Pixel Padding

In JVET-K0363, motion compensated boundary pixel padding is disclosed. When motion compensation is performed in the decoder side, it is possible that the motion vector points to a reference block that is partially or entirely located outside the reference slice. Without boundary padding, these pixels will be unavailable. Traditionally, the reference slice is padded using repetitive padding method which repeats the outer most pixel in each of the four directions for a certain amount of times depending on the padding size. These padded pixels can only provide very limited information since it is very likely that the padded area does not contain any meaningful content comparing to those that lie inside the boundary.

In ECM-5.0, bi-prediction is performed in a way that avoids relying on reference samples out of a reference picture boundary (Out of Boundary, OOB), if possible.

To do so, in the case of a bi-predicted block with an OOB reference block in one of the two reference pictures, the OOB prediction samples are not used. The concerned part of the block is rather uni-predicted based on non-OOB prediction samples, if available in the other reference picture.

However, for a uni-predicted block with an OOB reference block or for a bi-directional predicted block with both OOB reference samples, repetitive padded pixels are used instead of MC.

### Intra-Block-Copy (IBC) Mode

For a typical video with text and graphics, there are usually repetitive patterns within the same picture. Hence, intra (picture) block compensation has been observed to be very effective. A new prediction mode, i.e., the intra block copy (IBC) mode or called current picture referencing (CPR), was thus introduced for screen content coding to utilize this characteristic. In the IBC mode, a prediction unit (PU) is predicted from a previously reconstructed block within the same picture. Further, a displacement vector (called block vector or BV) is used to signal the relative displacement from the position of the current block to that of the reference block. The prediction errors are then coded using transformation, quantization and entropy coding. In this technique, the reference samples correspond to the reconstructed samples of the current decoded picture prior to in-loop filter operations, both deblocking and sample adaptive offset (SAO) filters in HEVC.

The very first version of IBC was proposed in to HEVC Range Extensions (RExt) development. In this version, the IBC compensation was limited to be within a small local area, with only 1-D block vector and only for block size of 2N×2N. Later, a more advanced IBC design was developed during the standardization of HEVC SCC

### Advanced Motion Vector Prediction Mode (AMVP)

In most coding standards, adaptive Inter/Intra prediction is used on a block basis.

In the Inter prediction mode, one or two motion vectors are determined for each block to select one reference block (i.e., uni-prediction) or two reference blocks (i.e., bi-prediction). The motion vector or motion vectors are determined and coded for each individual block. In HEVC, inter motion compensation is supported in two different ways: explicit signalling or implicit signalling. In explicit signalling, the motion vector for a block (i.e., PU) is signalled using a predictive coding method. The motion vector predictors correspond to motion vectors associated with spatial and temporal neighbours of the current block. The best MVP with the smallest motion vector difference (MVD) compared to the corresponding MV can be chosen for efficiently coding. Since the encoder and the decoder maintain a same set of MVPs, an MVP index is signalled the best MVP. After a MV predictor is determined, the motion vector difference (MVD) is coded and transmitted. This mode is also referred as AMVP (advanced motion vector prediction) mode. In implicit signalling, one predictor from a candidate predictor set is selected as the motion vector for the current block (i.e., PU). Since both the encoder and decoder will derive the candidate set and select the final motion vector in the same way, there is no need to signal the MV or MVD in the implicit mode. This mode is also referred as Merge mode. The forming of predictor set in Merge mode is also referred as Merge candidate list construction. An index, called Merge index, is signalled to indicate the predictor selected as the MV for current block.

There are two different schemes to implement OBMC. In the first scheme, OBMC blocks are pre-generated when doing motion compensation for each block. These OBMC blocks will be stored in a local buffer for neighbouring blocks. In the second scheme, the OBMC blocks are generated before the blending process of each block when doing OBMC.

In both schemes, several methods are proposed to reduce the computation complexity, especially for the interpolation filtering, and additional bandwidth requirement of OBMC.

### Template Matching Based OBMC

Recently, a template matching-based OBMC scheme has been proposed (JVET-Y0076) to the emerging international coding standard. As shown in FIG. 7, for each top block with a size of 4×4 at the top CU boundary, the above template size equals to 4×1. In FIG. 7, box 710 corresponds to a CU. If N adjacent blocks have the same motion information, then the above template size is enlarged to 4N×1 since the MC operation can be processed at one time, which is in the same manner in ECM-OBMC. For each left block with a size of 4×4 at the left CU boundary, the left template size equals to 1×4 or 1×4N.

For each 4×4 top block (or N 4×4 blocks group), the prediction value of boundary samples is derived according to the following steps:
Take block A as the current block and its above neighbouring block AboveNeighbour_A for example. The operation for left blocks is conducted in the same manner.
First, three template matching costs (Cost1, Cost2, Cost3) are measured by SAD between the reconstructed samples of a template and its corresponding reference samples derived by MC process according to the following three types of motion information:
i. Cost1 is calculated according to A's motion information.
ii. Cost2 is calculated according to AboveNeighbour_A's motion information.
iii. Cost3 is calculated according to weighted prediction of A's and AboveNeighbour_A's motion information with weighting factors as ¾ and ¼ respectively.
Second, choose one out of three approaches to calculate the final prediction results of boundary samples by comparing Cost1, Cost2 and Cost 3.

The original MC result using current block's motion information is denoted as Pixel1, and the MC result using neighbouring block's motion information is denoted as Pixel2. The final prediction result is denoted as NewPixel.
If Cost1 is minimum, then NewPixel(i,j)=Pixel1(i,j).
If (Cost2+(Cost2>>2)+(Cost2>>3))<=Cost1, then blending mode 1 is used.
   For luma blocks, the number of blending pixel rows is 4.

$$NewPixel ( i , 0 ) = ( 26 \times P i x e l 1 ( i , 0 ) + 6 \times P i x e l 2 ( i , 0 ) + 16 ) >> 5$$

$$NewP i x e l ( i , 1 ) = ( 7 \times P i x e l 1 ( i , 1 ) + P i x e l 2 ( i , 1 ) + 4 ) >> 3$$

$$NewP i x e l ( i , 2 ) = ( 15 \times P i x e l 1 ( i , 2 ) + P i x e l 2 ( i , 2 ) + 8 ) >> 4$$

$$NewP i x e l ( i , 3 ) = ( 31 \times P i x e l 1 ( i , 3 ) + P i x e l 2 ( i , 3 ) + 16 ) >> 5$$

For chroma blocks, the number of blending pixel rows is 1.

$$NewPixel ( i , 0 ) = ( 26 \times Pixel 1 ( i , 0 ) + 6 \times Pixel 2 ( i , 0 ) + 16 ) >> 5$$

If Cost1<=Cost2, then blending mode 2 is used.
   For luma blocks, the number of blending pixel rows is 2.

$$N e w P i x e l ( i , 0 ) = ( 15 \times P i x e l 1 ( i , 0 ) + P i x e l 2 ( i , 0 ) + 8 ) >> 4$$

$$NewPixel ( i , 1 ) = ( 31 \times P i x e l 1 ( i , 1 ) + P i x e l 2 ( i , 1 ) + 16 ) >> 5$$

For chroma blocks, the number of blending pixel rows/columns is 1.

$$NewPixel ( i , 0 ) = ( 15 \times Pixel 1 ( i , 0 ) + P i x e l 2 ( i , 0 ) + 8 ) >> 4$$

Otherwise, blending mode 3 is used.
   For luma blocks, the number of blending pixel rows is 4.

$$N e w P i x e l ( i , 1 ) = ( 7 \times P i x e l 1 ( i , 1 ) + P i x e l 2 ( i , 1 ) + 4 ) >> 3$$

$$NewPixel ( i , 2 ) = ( 15 \times P i x e l 1 ( i , 2 ) + P i x e l 2 ( i , 2 ) + 8 ) >> 4$$

$$NewPixel ( i , 3 ) = ( 31 \times P i x e l 1 ( i , 3 ) + P i x e l 2 ( i , 3 ) + 16 ) >> 5$$

For chroma blocks, the number of blending pixel rows is 1.

$$NewPixel ( i , 0 ) = ( 7 \times Pixel 1 ( i , 0 ) + P i x e l 2 ( i , 0 ) + 4 ) >> 3$$

### Non-EE2: Improvements on Local Illumination Compensation in ECM7.0

In JVET-AC0164 (Xiaoyu Xiu, et al., “Non-EE2: Improvements on local illumination compensation in ECM7.0”, Joint Video Exploration Team (JVET) of ITU-T SG 16 WP 3 and ISO/IEC JTC 1/SC 29/WG 11, 29th Meeting, by teleconference, 11-20 Jan. 2023, Document JVET-AC0164), techniques to improve local illumination compensation in ECM-7.0 are disclosed. According to ECM-7.0 (Muhammed Coban, et al., “Algorithm description of Enhanced Compression Model 7 (ECM 7)”, Joint Video Exploration Team (JVET) of ITU-T SG 16 WP 3 and ISO/IEC JTC 1/SC 29/WG 11, 28th Meeting, Mainz, DE, 20-28 Oct. 2022, Document JVET-AB2025), local illumination compensation (LIC) is one inter coding technique that aims at addressing the illumination variations between one block and its prediction block. The LIC is based on one linear model, where a scale α and an offset β are derived from the template samples neighbouring to the current block and their corresponding prediction samples. The derived LIC parameters are then applied to adjust the prediction samples of the block as

$${P}^{′} [ x , y ] = α \cdot P [ x , y ] + β$$

Currently, the LIC is only applicable to uni-predictive inter CUs, which contain no less than 32 luma samples.

Additionally, overlapped block motion compensation (OBMC) is another inter tool in ECM7.0, which alleviates the discontinuities among the prediction samples of inter blocks by adjusting the boundary prediction samples of one inter block/sub-block using its neighbouring block's MV. According to the existing ECM design, when the LIC is applied to one inter block, the OBMC is always disabled. Additionally, when one neighbouring block of the current CU applies the LIC, only its MVs are used to produce the corresponding prediction samples used for the OBMC process of the current CU.

The following modifications are proposed in JVET-AC0164 to further improve the coding efficiency of the LIC tool.

### Bi-Predictive LIC

It is proposed in JVET-AC0164 to extend the existing LIC design to bi-predicted CUs. Specifically, when applying the proposed method to one bi-prediction block, two different linear models are derived to compensate the illumination changes that exist between the current block and its two prediction blocks. Then, the final bi-prediction of the current block is calculated as the combination of two uni-prediction blocks after the LIC adjustment, i.e.,

$${P}^{′} [ x , y ] = ( 1 - ω ) \cdot {p}_{0}^{′} [ x , y ] + ω \cdot {p}_{1}^{′} [ x , y ] , and$$

$${p}_{0}^{′} [ x , y ] = {α}_{0} \cdot {P}_{0} [ x , y ] + {β}_{0}$$

$${p}_{1}^{′} [ x , y ] = {α}_{1} \cdot {P}_{1} [ x , y ] + {β}_{1}$$

where α₀ and β₀, and α₁ and β₁ indicate the scales and the offsets in L0 and L1, respectively; ω indicates the weight (as indicated by the CU-level BCW index) that is applied when combining the two uni-prediction blocks. Same to the current LIC design, one control flag is signalled for AMVP bi-predicted CUs to indicate the enabling/disabling of the LIC while the flag is inherited from one neighbouring block for merge inter CUs (including AMVP-Merge mode). Additionally, the LIC is disabled when decoder-side motion vector refinement (DMVR) (including multi-pass DMVR, adaptive DMVR and affine DMVR) and bi-directional optical flow (BDOF) is applied.

To reuse the linear model derivation of the existing LIC, one iterative approach is applied to alternately derive the L0 and L1 linear models. Specifically, given the two MVs of the current block, it assumes T₀ and T₁ are the two predictions of the current block's template T. The method firstly derives the L0 linear model (α₀ and β₀) that result in the minimum difference between T₀ and T; Then, the L1 linear model (α₁ and β₁) can be calculated that minimizes the difference between T₁ and the updated template. Finally, the L0 linear model is refined again in the same way.

In this application, parameters associated with coding tools applied to the current block and/or the neighbouring block are inherited from the current block and/or the neighbouring block during the OBMC process.

### BRIEF SUMMARY OF THE INVENTION

A method and apparatus for video coding using Overlapped Block Motion Compensation (OBMC) are disclosed. According to this method, input data comprising a current block, a current subblock, a neighbouring block, or a neighbouring subblock are received. One or more parameters associated with one or more coding tools applied to the neighbouring block, the neighbouring subblock, the current block, the current subblock or a combination thereof are determined, wherein at least one of said one or more parameters is inherited from the neighbouring block, the neighbouring subblock, the current block, the current subblock or the combination thereof. In one embodiment, said one or more coding tools belong to a group comprising LIC (Local Illumination Compensation), BCW (Bi-Prediction with CU-level Weight), BDOF (Bi-Directional Optical Flow), DMVR (Decoder-Side Motion Vector Refinement), GPM (Geometric Partitioning Mode), CIIP (Combined Inter and Intra Prediction), MMVD (Merge Mode with MVD), OOB (Out Of Boundary), AMVP (Advanced Motion Vector Prediction), IBC (Intra Block Copy), or any combination thereof. OBMC (Overlapped Block Motion Compensation) process is applied to at least one boundary of the current block, the current subblock, the neighbouring block and the neighbouring subblock according to OBMC parameters comprising said at least one of said one or more parameters.

In one embodiment, said one or more parameters correspond to one or more LIC parameters, interpolation filter type, BCW index, BDOF type, DMVR type, GPM type, template matching type, CIIP type, MMVD type, MMVD index, OOB type, AMVP-merge type, IBC type, or a combination thereof.

In one embodiment, said at least one of said one or more parameters is inherited from the neighbouring block, the neighbouring subblock, the current block or the current subblock with one or more constraints. In one embodiment, said one or more constraints comprise CTU constraint, CTU row constraint, CTU column constraint, block characteristics, OOB condition, or a combination thereof.

In one embodiment, said one or more parameters correspond to motion information associated with the neighbouring block, the neighbouring subblock, the current block, the current subblock or the combination thereof. In one embodiment, the motion information is inherited from the neighbouring block, the neighbouring subblock, the current block or the current subblock with one or more constraints. In one embodiment, said one or more constraints comprise CTU constraint, CTU row constraint, CTU column constraint, block characteristics, OOB condition, or a combination thereof. In one embodiment, the motion information comprises MV (Motion Vector), integer MV, affine model, affine motion, control-point MVs, inter-prediction direction, merge index or a combination thereof.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of overlapped motion compensation for geometry partitions.

FIGS. 3A-B illustrate an example of OBMC for 2N×N (FIG. 3A) and N×2N blocks (FIG. 3B).

FIG. 4A illustrate an example of the sub-blocks that OBMC is applied, where the example includes subblocks at a CU/PU boundary.

FIG. 4B illustrate an example of the sub-blocks that OBMC is applied, where the example includes subblocks coded in the AMVP mode.

FIG. 5 illustrate an example of the OBMC processing using neighbouring blocks from above and left for the current block.

FIG. 6A illustrate an example of the OBMC processing for the right and bottom part of the current block using neighbouring blocks from right and bottom.

FIG. 6B illustrate an example of the OBMC processing for the right and bottom part of the current block using neighbouring blocks from right, bottom and bottom-right.

FIG. 7 illustrates an example of Template Matching based OBMC where, for each top block with a size of 4×4 at the top CU boundary, the above template size equals to 4×1.

FIG. 8 illustrates an example where neighbouring MVs required in OBMC process are inherited from neighbouring block's MV instead of from neighbouring subblock's MVs when OBMC is applied to the current block or current subblocks according to an embodiment of the present invention.

FIG. 9 illustrates an example of parameters inheritance when neighbouring blocks or neighbouring subblocks are across CTU. In this example, neighbouring blocks A and B are in CTU A and the current block is in CTU B according to an embodiment of the present invention.

FIG. 10 illustrates an example of motion inheritance when neighbouring blocks or neighbouring subblocks are across a CTU. In this example, neighbouring blocks A and B are in CTU A and the current block is in CTU B according to an embodiment of the present invention.

FIG. 11 illustrates an example of extrapolated MVs for right and bottom CU-boundary OBMC according to an embodiment of the present invention.

FIG. 12 illustrates an example of CU-boundary OBMC with neighbouring inter-predicted and intra-predicted reconstruction blocks according to an embodiment of the present invention.

FIG. 13 illustrates an example of boundary-matching-based subblock OBMC according to an embodiment of the present invention.

FIG. 14 illustrates a flowchart of an exemplary video coding system, where parameters associated with coding tools applied to the current block and/or the neighbouring block are inherited from the current block and/or the neighbouring block during the OBMC process according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Parameters Inheritance in OBMC

In the proposed method, some parameters in OBMC are inherited from neighbouring blocks or from the current block. Some parameters are inherited from neighbouring blocks or neighbouring subblocks or the current block or current subblocks, for example, but not limited to, LIC parameters, interpolation filter type (signalled index or flag or inferred), BCW index, BDOF type, DMVR type, GPM type, template matching type, CIIP type, MMVD type and MMVD index, OOB (Out-of-Boundary) type, AMVP-merge type, IBC type, or a combination thereof. When generating OBMC predictor, inherited parameters are used. Parameters required in OBMC process can be partially from neighbouring blocks or neighbouring subblocks and partially from current block or current subblocks, or all from neighbouring blocks or neighbouring subblocks or all from current block or current subblocks.

In one embodiment, when generating OBMC predictors, LIC parameters are inherited from neighbouring blocks or neighbouring subblocks when LIC is applied to neighbouring blocks or neighbouring subblocks.

In another embodiment, when generating OBMC predictors, LIC parameters are inherited from neighbouring blocks or neighbouring subblocks when LIC is applied to the current block or the current subblocks.

In one embodiment, when generating OBMC predictors, LIC parameters are inherited from current blocks or current subblocks when LIC is applied to neighbouring blocks or neighbouring subblocks.

In another embodiment, when generating OBMC predictors, LIC parameters are inherited from current blocks or current subblocks when LIC is applied to the current block or current subblocks.

In another embodiment, when generating OBMC predictors, only partial LIC parameters are inherited, for example, α or β when LIC is applied.

In another embodiment, when generating OBMC predictors, interpolation filter type is inherited from neighbouring blocks or neighbouring subblocks when interpolation is performed at neighbouring blocks or neighbouring subblocks.

In another embodiment, when generating OBMC predictors, interpolation filter type is inherited from neighbouring blocks or neighbouring subblocks when interpolation is performed at the current block or the current subblocks.

In another embodiment, when generating OBMC predictors, interpolation filter type is inherited from the current block or the current subblocks when interpolation is performed at neighbouring blocks or neighbouring subblocks.

In another embodiment, when generating OBMC predictors, interpolation filter type is inherited from the current block or the current subblocks when interpolation is performed at the current block or the current subblocks.

In another embodiment, when generating OBMC predictors, only partial interpolation filter type is inherited, for example, half-pel interpolation type, when interpolation filter is performed.

In another embodiment, when generating OBMC predictors, only partial interpolation filter type is inherited, for example, 8-tap interpolation type or 12-tap interpolation type, when interpolation filter is performed.

In another embodiment, when generating OBMC predictors, only partial interpolation filter type is inherited. For example, only luma interpolation filter type or chroma interpolation filter type is inherited when interpolation filter is performed.

In another embodiment, when generating OBMC predictors, BCW index is inherited from neighbouring blocks or neighbouring subblocks when BCW is performed at neighbouring blocks or neighbouring subblocks.

In another embodiment, when generating OBMC predictors, BCW index is inherited from neighbouring blocks or neighbouring subblocks when BCW is performed at the current block or the current subblocks.

In another embodiment, when generating OBMC predictors, BCW index is inherited from the current block or current subblocks when BCW is performed at neighbouring blocks or neighbouring subblocks.

In another embodiment, when generating OBMC predictors, BCW index is inherited from the current block or current subblocks when BCW is performed at the current block or current subblocks.

In another embodiment, when generating OBMC predictors, only partial weightings in BCW index are inherited, for example, weightings from List0 or weightings from List1 when BCW is performed at the current block or current subblocks.

In another embodiment, when generating OBMC predictors, BDOF type is inherited from neighbouring blocks or neighbouring subblocks when BDOF is performed at neighbouring blocks or neighbouring subblocks.

In another embodiment, when generating OBMC predictors, BDOF type is inherited from neighbouring blocks or neighbouring subblocks when BDOF is performed at the current block or current subblocks.

In another embodiment, when generating OBMC predictors, BDOF type is inherited from the current blocks or current subblocks when BDOF is performed at neighbouring blocks or neighbouring subblocks.

In another embodiment, when generating OBMC predictors, BDOF type is inherited from the current block or current subblocks when BDOF is performed at the current block or the current subblocks.

In another embodiment, when generating OBMC predictors, DMVR type is inherited from neighbouring blocks or neighbouring subblocks when DMVR is performed at neighbouring blocks or neighbouring subblocks.

In another embodiment, when generating OBMC predictors, DMVR type is inherited from neighbouring blocks or neighbouring subblocks when DMVR is performed at the current block or the current subblocks.

In another embodiment, when generating OBMC predictors, DMVR type is inherited from the current blocks or current subblocks when DMVR is performed at neighbouring blocks or neighbouring subblocks.

In another embodiment, when generating OBMC predictors, DMVR type is inherited from the current block or current subblocks when DMVR is performed at the current block or current subblocks.

In another embodiment, when generating OBMC predictors, only some subblocks will inherited refined MV from DMVR process when DMVR is performed at the current block or current subblocks.

In another embodiment, when generating OBMC predictors, when DMVR type is inherited from the current block or current subblocks, the MV refinement range is decreased.

In another embodiment, when generating OBMC predictors, when DMVR type is inherited from neighbouring blocks or neighbouring subblocks, the MV refinement range is decreased.

In another embodiment, when generating OBMC predictors, GPM type is inherited from neighbouring blocks or neighbouring subblocks when GPM is performed at neighbouring blocks or neighbouring subblocks.

In another embodiment, when generating OBMC predictors, GPM type is inherited from neighbouring blocks or neighbouring subblocks when GPM is performed at the current block or current subblocks.

In another embodiment, when generating OBMC predictors, GPM type is inherited from the current block or current subblocks when GPM is performed at neighbouring blocks or neighbouring subblocks.

In another embodiment, when generating OBMC predictors, GPM type is inherited from the current block or current subblocks when GPM is performed at the current block or current subblocks.

In another embodiment, when generating OBMC predictors, only partial GPM type is inherited from neighbouring blocks or neighbouring subblocks, for example, partitioning index, merge index of one partition, MV of one partition, when GPM is performed at the current block or current subblocks.

In another embodiment, when generating OBMC predictors, only partial GPM type is inherited from the current block or current subblocks, for example, partitioning index, merge index of one partition, MV of one partition, when GPM is performed at the current block or current subblocks.

In another embodiment, when generating OBMC predictors, template matching type is inherited from neighbouring blocks or neighbouring subblocks when template matching is performed at neighbouring blocks or neighbouring subblocks.

In another embodiment, when generating OBMC predictors, template matching type is inherited from neighbouring blocks or neighbouring subblocks when template matching is performed at the current block or current subblocks.

In another embodiment, when generating OBMC predictors, template matching type is inherited from the current block or current subblocks when template matching is performed at neighbouring blocks or neighbouring subblocks.

In another embodiment, when generating OBMC predictors, template matching type is inherited from the current block or current subblocks when template matching is performed at the current block or the current subblocks.

In another embodiment, when generating OBMC predictors, only partial template matching type is inherited. For example, only horizontal or vertical motion shift is inherited when template matching is performed at the current block or current subblocks.

In another embodiment, when generating OBMC predictors, CIIP type is inherited from neighbouring blocks or neighbouring subblocks when CIIP is performed at neighbouring blocks or neighbouring subblocks.

In another embodiment, when generating OBMC predictors, CIIP type is inherited from neighbouring blocks or neighbouring subblocks when CIIP is performed at the current block or current subblocks.

In another embodiment, when generating OBMC predictors, CIIP type is inherited from the current blocks or current subblocks when CIIP is performed at neighbouring blocks or neighbouring subblocks.

In another embodiment, when generating OBMC predictors, CIIP type is inherited from the current block or current subblocks when CIIP is performed at the current block or current subblocks.

In another embodiment, when generating OBMC predictors, only partial CIIP type is inherited from neighbouring blocks or neighbouring subblocks, for example, weightings of inter-prediction or weightings of intra prediction, when CIIP is performed at the current block or current subblocks.

In another embodiment, when generating OBMC predictors, only partial CIIP type is inherited from the current block or current subblocks, for example, weightings of inter-prediction or weightings of intra prediction, when CIIP is performed at the current block or current subblocks.

In another embodiment, when generating OBMC predictors, MMVD type or MMVD index is inherited from neighbouring blocks or neighbouring subblocks when MMVD is performed at neighbouring blocks or neighbouring subblocks.

In another embodiment, when generating OBMC predictors, MMVD type or MMVD index is inherited from neighbouring blocks or neighbouring subblocks when MMVD is performed at the current block or current subblocks.

In another embodiment, when generating OBMC predictors, MMVD type or MMVD index is inherited from the current block or current subblocks when MMVD is performed at neighbouring blocks or neighbouring subblocks.

In another embodiment, when generating OBMC predictors, MMVD type or MMVD index is inherited from the current block or current subblocks when MMVD is performed at the current block or current subblocks.

In another embodiment, when generating OBMC predictors, only partial MMVD type is inherited from neighbouring blocks or neighbouring subblocks, for example, horizontal or vertical MMVD offset, when MMVD is performed at the current block or current subblocks.

In another embodiment, when generating OBMC predictors, only partial MMVD type is inherited from the current block or current subblocks, for example, horizontal or vertical MMVD offset, when MMVD is performed at the current block or current subblocks.

In another embodiment, when generating OBMC predictors, OOB type is inherited from neighbouring blocks when neighbouring blocks or neighbouring subblocks are OOB.

In another embodiment, when generating OBMC predictors, OOB type is inherited from neighbouring blocks or neighbouring subblocks when the current block or current subblocks are OOB.

In another embodiment, when generating OBMC predictors, OOB type is inherited from the current block or current subblocks when neighbouring blocks or neighbouring subblocks are OOB.

In another embodiment, when generating OBMC predictors, OOB type is inherited from the current block or current subblocks when the current block or current subblocks are OOB.

In another embodiment, when generating OBMC predictors, only partial OOB type is inherited from neighbouring blocks or neighbouring subblocks, for example, reference samples within boundary, final predictor samples within boundary, when neighbouring blocks or neighbouring subblocks are OOB.

In another embodiment, when generating OBMC predictors, only partial OOB type is inherited from the current block or current subblocks. For example, only reference samples within boundary or final predictor samples within boundary is inherited when current block or current subblocks are OOB.

In another embodiment, when generating OBMC predictors, AMVP-merge type is inherited from neighbouring blocks or neighbouring subblocks when AMVP-merge is performed at neighbouring blocks or neighbouring subblocks.

In another embodiment, when generating OBMC predictors, AMVP-merge type is inherited from neighbouring blocks or neighbouring subblocks when AMVP-merge is performed at the current block or current subblocks.

In another embodiment, when generating OBMC predictors, AMVP-merge type is inherited from the current block or current subblocks when AMVP-merge is performed at neighbouring blocks or neighbouring subblocks.

In another embodiment, when generating OBMC predictors, AMVP-merge type is inherited from the current block or current subblocks when AMVP-merge is performed at the current block or current subblocks.

In another embodiment, when generating OBMC predictors, only partial AMVP-merge type is inherited from neighbouring blocks or neighbouring subblocks. For example, only merge index or MV is inherited when AMVP-merge is performed at the current block or current subblocks.

In another embodiment, when generating OBMC predictors, only partial AMVP-merge type is inherited from the current block or current subblocks. For example, only merge index or MV is inherited when AMVP-merge is performed at the current block or current subblocks.

In another embodiment, when generating OBMC predictors, IBC type is inherited from neighbouring blocks or neighbouring subblocks when IBC is performed at neighbouring blocks or neighbouring subblocks.

In another embodiment, when generating OBMC predictors, IBC type is inherited from neighbouring blocks or neighbouring subblocks when IBC is performed at the current block or current subblocks.

In another embodiment, when generating OBMC predictors, IBC type is inherited from the current block or current subblocks when IBC is performed at neighbouring blocks or neighbouring subblocks.

In another embodiment, when generating OBMC predictors, IBC type is inherited from the current block or current subblocks when IBC is performed at the current block or current subblocks.

In another embodiment, when generating OBMC predictors, only partial IBC type is inherited from neighbouring blocks or neighbouring subblocks. For example, only merge index or MV is inherited when IBC is performed at the current block or current subblocks.

In another embodiment, when generating OBMC predictors, only partial IBC type is inherited from the current block or current subblocks. For example, only merge index or MV is inherited when IBC is performed at the current block or current subblocks.

### Motion Inheritance in OBMC

In the proposed method, motions in OBMC are inherited from neighbouring blocks or neighbouring subblocks or from the current block or current subblocks. Motions are inherited from neighbouring blocks or neighbouring subblocks or from the current block or current subblocks, for example, but not limited to, MV, integer MV, affine model, affine motion, control-point MVs, inter-prediction direction (for example, uni-prediction List0, uni-prediction List1, bi-prediction), merge index or a combination thereof. When generating OBMC predictors, inherited motions are used. Motions required in OBMC process can be partially from neighbouring blocks or neighbouring subblocks and partially from the current block or current subblocks, or all from neighbouring blocks or neighbouring subblocks or all from the current block or current subblocks.

In one embodiment, as shown in FIG. 8., when generating OBMC predictors, neighbouring MVs required in OBMC process are inherited from neighbouring block's MV, instead of from neighbouring subblock's MVs, when OBMC is applied to current block or current subblocks. In FIG. 8, the current block 810 is shown as a thick-lined box and the neighbouring block 820 is shown as a dot-dash lined box. Subblocks A, B, C and D are inside the current block and subblocks E, F, G and H are in the neighbouring block. The motion vectors for the neighbouring subblocks (e.g. MV 822 for subblock E and MV 824 for subblock H) are shown as dash-lined arrows. MV 826 is the motion vector for the neighbouring block.

In one embodiment, as shown in FIG. 8, when generating OBMC predictors, neighbouring integer MVs required in OBMC process are inherited from neighbouring block's integer MV, instead of from neighbouring subblock's integer MVs, when OBMC is applied to the current block or current subblocks.

In another embodiment, when generating OBMC predictors, neighbouring block's affine model or affine motion is inherited, instead of neighbouring subblock affine model or affine motion, when OBMC is applied to the current block or current subblocks.

In another embodiment, when generating OBMC predictors, neighbouring block's control-point MVs is inherited, instead of neighbouring subblock control-point MVs, when OBMC is applied to the current block or current subblocks.

In another embodiment, when generating OBMC predictors, neighbouring block's inter-prediction direction (uni-prediction List0 or uni-prediction List1 or bi-prediction) is inherited, instead of neighbouring subblock inter-prediction direction (uni-prediction List0 or uni-prediction List1 or bi-prediction), when OBMC is applied to the current block or current subblocks.

In another embodiment, when generating OBMC predictors, neighbouring block's inter-prediction direction (uni-prediction List0 or uni-prediction List1 or bi-prediction) is inherited, instead of neighbouring subblock inter-prediction direction (uni-prediction List0 or uni-prediction List1 or bi-prediction), when OBMC is applied to the current block or current subblocks.

In another embodiment, when generating OBMC predictors, neighbouring block's merge index is inherited, instead of neighbouring subblock merge index, when OBMC is applied to the current block or current subblocks.

### Adaptive Inheritance in OBMC

In the proposed method, parameters inheritance from neighbouring blocks or neighbouring subblocks or from the current block or current subblocks in OBMC is adaptively determined based on some metrics. Parameter inheritance in OBMC is adaptively determined based on, but not limited to, cost-metrics, the first neighbouring subblock or the current subblock in a block, the first neighbouring block or the current block in a CTU, or a combination thereof. The adaptive parameters inheritance can be partially from neighbouring blocks or neighbouring subblocks and partially from the current block or current subblocks, or all from neighbouring blocks or neighbouring subblocks or all from the current block or current subblocks.

In one embodiment, parameter inheritance in OBMC is adaptively determined based on cost-metrics, such as differences, SAD, SATD or SSE between neighbouring blocks and the current block, neighbouring subblocks and the current block, neighbouring blocks and current subblocks, or neighbouring subblocks and current subblocks when OBMC is performed at the current block or the current subblocks.

In another embodiment, parameter inheritance in OBMC is adaptive determined based on cost-metrics, such as template matching costs, boundary matching costs between neighbouring blocks and the current block, neighbouring subblocks and the current block, neighbouring blocks and current subblocks, or neighbouring subblocks and current subblocks when OBMC is performed at the current block or the current subblocks.

In another embodiment, parameter inheritance in OBMC is adaptive determined based on the first neighbouring subblock, the current subblock in a block, the first neighbouring block or the current block in a CTU, when OBMC is performed at the current block or the current subblocks.

### Simplification of Parameters Inheritance in OBMC

Some simplified methods of parameters inheritance in OBMC are disclosed. In the proposed method, some parameters in OBMC process are inherited from neighbouring blocks or from the current block. When parameters are inherited from neighbouring blocks or neighbouring subblocks in OBMC process, some constraints such as CTU constraint, CTU row constraint, CTU column constraint, block characteristics, OOB condition, etc. are considered. For example, the parameters can be LIC parameters, interpolation filter type (signalled index or flag or inferred), BCW index, BDOF type, DMVR type, GPM type, template matching type, CIIP type, MMVD type and MMVD index, OOB (Out-of-Boundary) type, AMVP-merge type, IBC type, or a combination thereof.

In one embodiment, parameters inheritance in OBMC process are from neighbouring blocks or neighbouring subblocks within the same CTU or the same CTU row or the same CTU column.

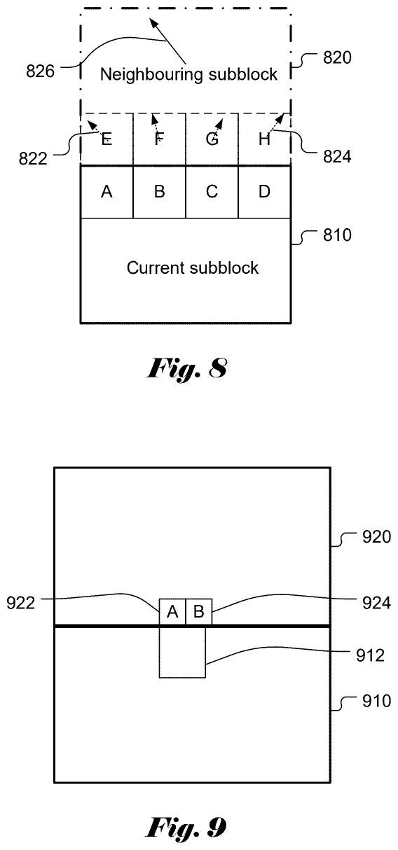

In another embodiment, when neighbouring blocks or neighbouring subblocks are across the current CTU or current CTU row or current CTU column, parameter inheritance in OBMC process is from the current block or current subblocks, as shown in FIG. 9. In FIG. 9, neighbouring blocks 922 and 924 are in a neighbouring CTU 920 and current block 912 is the current CTU 910.

In another embodiment, when neighbouring blocks or neighbouring subblocks are across current CTU or current CTU row or current CTU column, parameter inheritance in OBMC process is set to some pre-defined value or default value or disabled, as shown in FIG. 9.

In another embodiment, when neighbouring blocks or neighbour subblocks are OOB, parameter inheritance in OBMC process is from the current blocks or current subblocks.

In another embodiment, when neighbouring blocks or neighbour subblocks are OOB, parameter inheritance in OBMC process is set to some pre-defined value or default value or disabled.

In another embodiment, when neighbouring blocks or neighbour subblocks are different from the current block's characteristics, parameter inheritance in OBMC process is from the current block or current subblocks. The difference between neighbouring blocks' characteristics and current blocks' characteristics can be, but not limited to, large difference in luma area size or large difference in block aspect ratio.

In another embodiment, when neighbouring blocks or neighbour subblocks are different from the current block's characteristics, parameter inheritance in OBMC process is set to a pre-defined value or default value, or disabled. The difference between neighbouring blocks' characteristics and current blocks' characteristics can be, but not limited to, large difference in luma area size or large difference in block aspect ratio.

In another embodiment, when adaptive inheritance in OBMC process is applied, same CTU, same CTU row or same CTU column or OOB constraints are considered. When these constraints are met, adaptive inheritance of parameter information in OBMC process is only from the current block or current subblocks, disabled or set parameters to a pre-defined value or default value.

### Simplification of Motion Inheritance in OBMC

Some simplified methods of motion inheritance in OBMC are disclosed. In the proposed method, some motions in OBMC process are inherited from neighbouring blocks or from the current block. When motions are inherited from neighbouring blocks or neighbouring subblocks in OBMC process, some constraints such as CTU constraint, CTU row constraint, CTU column constraint, block characteristics, OOB condition, etc. are considered. Motions can be MV, integer MV, affine model, affine motion, control-point MVs, inter-prediction direction (for example, uni-prediction list0, uni-prediction list1, bi-prediction), merge index or a combination thereof.

In one embodiment, motion inheritance in OBMC process is from neighbouring blocks or neighbouring subblocks within the same CTU, the same CTU row or the same CTU column.

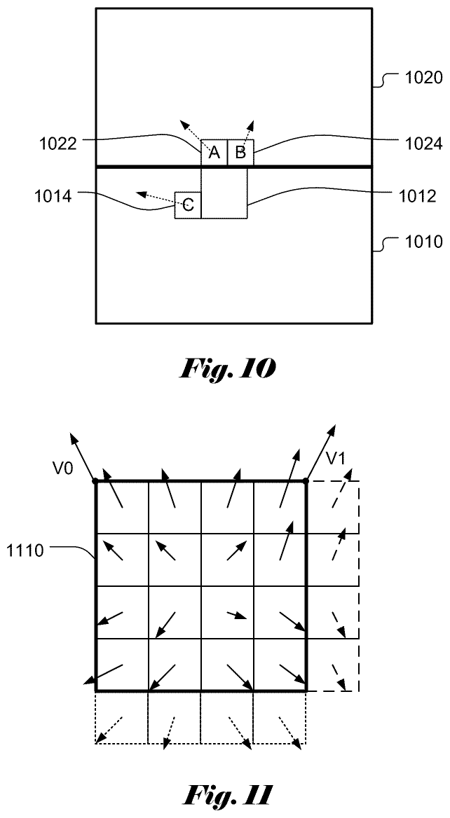

In another embodiment, when neighbouring blocks or neighbouring subblocks are across the current CTU, current CTU row or current CTU column, motion inheritance in OBMC process is from the current block or current subblocks, as shown in FIG. 10. In FIG. 10, neighbouring blocks A (1022) and B (1024) are in a neighbouring CTU 1020 and block 1014 is a neighbouring block of the current block 1012 in the current CTU 1010.

In another embodiment, when neighbouring blocks or neighbouring subblocks are across the current CTU, current CTU row or current CTU column, motion inheritance in OBMC process is set to some pre-defined or default value, or disabled, as shown in FIG. 10.

In another embodiment, when neighbouring blocks or neighbour subblocks are OOB, motion inheritance in OBMC process is from the current block or current subblocks.

In another embodiment, when neighbouring blocks or neighbour subblocks are OOB, motion inheritance in OBMC process is set to a pre-defined or default value, or disabled.

In another embodiment, when neighbouring blocks or neighbour subblocks are different from the current block's characteristics, motion inheritance in OBMC process is from the current block or current subblocks. The difference between neighbouring blocks' characteristics and current blocks' characteristics can be, but not limited to, large difference in luma area size or large difference in block aspect ratio.

In another embodiment, when neighbouring blocks or neighbour subblocks are different from the current block's characteristics, motion inheritance in OBMC process is set to some pre-defined value or default value or disabled. The difference between neighbouring blocks' characteristics and current blocks' characteristics can be, but not limited to, large difference in luma area size or large difference in block aspect ratio.

In another embodiment, when adaptive inheritance in OBMC process is applied, same CTU, same CTU row or same CTU column or OOB constraints are considered. When these constraints are met, adaptive inheritance in motion information in OBMC process is only from the current block or current subblocks, disabled or set parameters to some pre-defined value or default value.

### Right and Bottom CU-Boundary OBMC

A new block boundary handling method in OBMC is proposed. In this proposed method, OBMC is performed at the right boundary and bottom boundary of the current block. Conventionally, OBMC is performed only at top boundary and left boundary of the current block because of the availability of neighbouring reconstructed blocks. Since the neighbouring motion at right boundary and bottom boundary is unavailable, OBMC cannot be applied at these two boundaries. According to the present invention, OBMC can use extrapolated MVs to perform right and bottom CU-boundary OBMC by using the extrapolated MVs.

In one embodiment, as shown in FIG. 11, motion vectors are extrapolated using control-point MVs in affine mode. In FIG. 11, the thick-lined box 1110 indicates the boundary of a CU and the two control-point MVs are labelled as V0 and V1. The motion vector for each 4×4 block is derived from the control-point MVs.

In one embodiment, as shown in FIG. 11, by exploiting the CPMVs in affine mode, extrapolated MVs (shown as dash-lined arrows) are derived for each subblock at the right and bottom sides of the CU boundary. The subblock size can be 4×4 or other block size. OBMC can be performed using neighbouring extrapolated MVs and current subblock MVs.

In another embodiment, as shown in FIG. 11, the extrapolated MVs are calculated using motion difference between current block and neighbouring reconstruction block.

In another embodiment, as shown in FIG. 11, the extrapolated MVs are calculated by averaging CPMVs.

In another embodiment, as shown in FIG. 11, the extrapolated MVs are derived by choosing the largest component in horizontal and vertical direction.

In another embodiment, as shown in FIG. 11, the extrapolated MVs are derived by using the temporal collocated MVs.

In another embodiment, the weightings for the CU-boundary OBMC for right and bottom CU-boundary can be different (smaller or larger) from CU-boundary OBMC for top and left CU-boundary.

OBMC with LIC

In JVET-AC0164, the following two changes are applied to better handle the interaction between the LIC and the OBMC:
1) It is proposed to enable the OBMC to the inter blocks where the LIC is applied. Additionally, to achieve a better complexity/performance trade-off, the OBMC is only applied for refining the prediction samples on the top and left boundaries of one LIC CU while the OBMC on the internal sub-block boundaries are always disabled.
2) Besides the MVs, it is proposed to also take the LIC parameters of one neighbouring block (when it is coded by the LIC) into consideration when generating its corresponding prediction samples for the OBMC of the current CU.

### EE2-2.11e: Adaptive OBMC Control

JVET-AD0193 (Kai Cui, et al., “Non-EE2: Improvements on local illumination compensation in ECM7.0”, Joint Video Exploration Team (JVET) of ITU-T SG 16 WP 3 and ISO/IEC JTC 1/SC 29/WG 11, 30th Meeting, Antalya, TR, 21-28 Apr. 2023, Document JVET-AD0193) proposes modifications to OBMC. The proposed modifications include the following aspects:
1) OBMC flag is inherited from a neighbouring affine block for affine merge mode.
2) OBMC is not applied to a block if there is a neighbour block coded with IBC, palette, or BDPCM modes.
3) When applying OBMC to a block, block boundary check to decide whether OBMC is applied to the boundary is further made based on the reference samples of the current block. If any absolute difference between the prediction sample and non-interpolated (integer pel) reference sample is greater than a threshold, the OBMC is not applied to that boundary.
   OBMC with Unavailable Neighbouring Motion

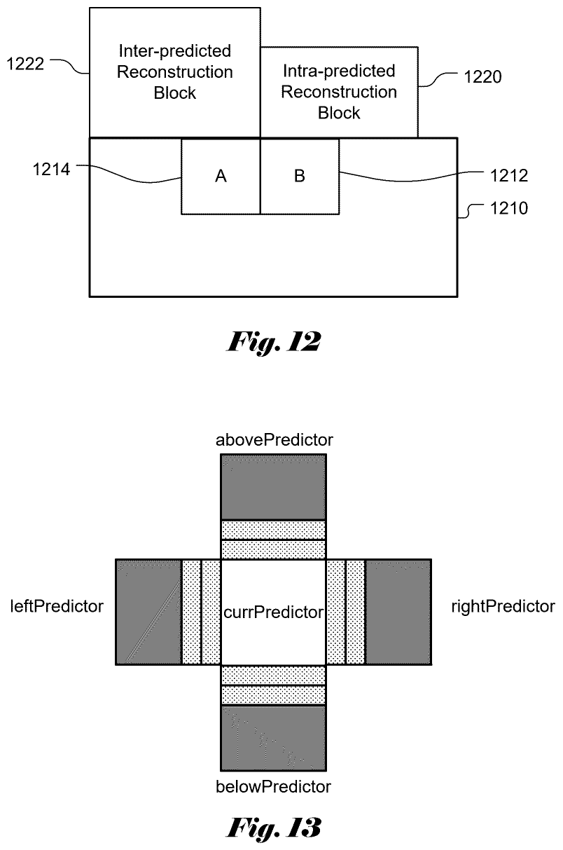

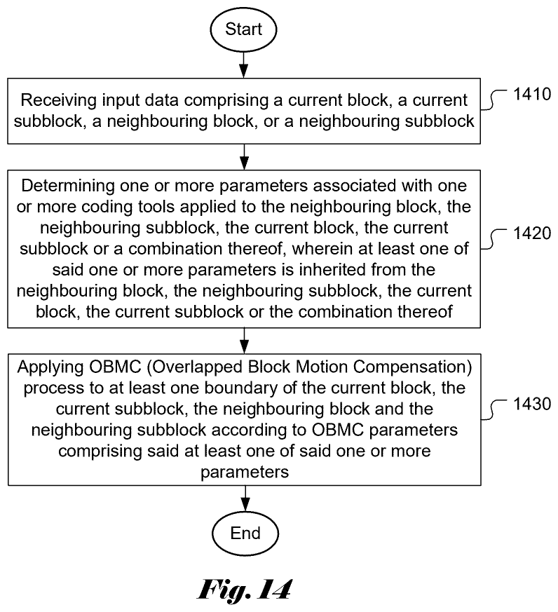

A new block smoothing method in OBMC is proposed. In conventional CU-boundary OBMC, when a neighbouring block is an intra-predicted block or IBC-predicted block, CU-boundary OBMC is skipped at current subblock due to unavailable motion (e.g. subblock B) as shown in FIG. 12. In the new proposed method, when CU-boundary OBMC is skipped, another boundary smoothing method is performed to eliminate the discontinuity between current inter-predictor and neighbouring non-inter reconstruction.

In one embodiment, as shown in FIG. 12, when neighbouring motion (e.g. subblock B) does not exist, a planar predictor or DC predictor is generated and blended with current subblock.

In another embodiment, as shown in FIG. 12, when neighbouring motion (e.g. subblock B) does not exist, boundary strength similar to deblocking filter is calculated and smoothing filter is applied at the current subblock according to the boundary strength.

In another embodiment, as shown in FIG. 12, when neighbouring motion (e.g. subblock B) does not exist, edge offset similar to SAO is calculated and smoothing filter is applied at current subblock according to the boundary strength.

### Boundary-Matching-Based Subblock OBMC

A new boundary-matching-based method in OBMC is proposed. Conventionally, the blending weighting in subblock OBMC is calculated by certain rules. In the new proposed method, boundary matching is performed to calculate the continuity between the current subblock boundary and the neighbouring subblock boundary. According to the boundary matching costs, OBMC can be performed using different weighting in a subblock-OBMC blending process.

In one embodiment, as shown in FIG. 13, one or more lines in neighbouring subblocks and one or more lines in the current subblock are used to calculate the boundary-matching cost.

In another embodiment, as shown in FIG. 13, the neighbouring subblocks with larger boundary-matching costs are blended using larger weighting in subblock-boundary OBMC blending process.

In another embodiment, in a different prediction mode (e.g., affine mode and DMVR mode), the weightings for subblock-boundary OBMC according to boundary-matching costs are different or adaptively changed.

In another embodiment, a threshold for boundary-matching cost is set. When the boundary matching cost between the current subblock and the neighbouring subblock is larger than the threshold, subblock-boundary OBMC will be performed. Otherwise, the subblock-boundary OBMC will not consider this neighbouring subblock.

A new predictor-based method in OBMC is proposed. In the proposed method, blending weighting or blending lines or blending regions in OBMC are adaptively changed according to predictor characteristics. Predictor characteristics may correspond to predictor intensity difference of current block and OBMC predictor for luma, predictor intensity difference of current block and OBMC predictor for chroma, predictor intensity gradients of the current block for luma, predictor intensity gradients of OBMC predictor for luma, predictor intensity gradients of the current block for chroma, predictor intensity gradients of OBMC predictor for chroma, or predictor prediction modes. The blending weighting can be increased or decreased according to the predictor characteristics. The blending lines or blending regions can also be increased or decreased according to the predictor characteristics. The weightings can be for two predictors from the current predictor and a neighbouring predictor or only from the current predictor. The blending lines or blending regions can contain two predictors from the current predictor and a neighbouring predictor, or the blending lines or blending regions can be 0, that is, no blending from neighbouring predictors.

In one embodiment, when the predictor intensity difference of the current block and OBMC predictor in luma is larger or smaller than a threshold, the blending weightings in OBMC are increased. The threshold can be signalled or pre-defined.

In another embodiment, when the predictor intensity difference of the current block and OBMC predictor in luma is larger or smaller than a threshold, the blending weightings in OBMC are decreased. The threshold can be signalled or pre-defined.

In another embodiment, when the predictor intensity difference of the current block and OBMC predictor in chroma is larger or smaller than a threshold, the blending weightings in OBMC are increased. The threshold can be signalled or pre-defined.

In another embodiment, when the predictor intensity difference of the current block and OBMC predictor in chroma is larger or smaller than a threshold, the blending weightings in OBMC are decreased. The threshold can be signalled or pre-defined.

In another embodiment, when the predictor intensity difference of the current block and OBMC predictor in luma is larger or smaller than a threshold, the blending lines or the blending regions in OBMC are increased. The threshold can be signalled or pre-defined.

In another embodiment, when the predictor intensity difference of the current block and OBMC predictor in luma is larger or smaller than a threshold, the blending lines or the blending regions in OBMC are decreased. The threshold can be signalled or pre-defined.

In another embodiment, when the predictor intensity difference of the current block and OBMC predictor in chroma is larger or smaller than a threshold, the blending lines or the blending regions in OBMC are increased. The threshold can be signalled or pre-defined.

In another embodiment, when the predictor intensity difference of the current block and OBMC predictor in chroma is larger or smaller than a threshold, the blending lines or the blending regions in OBMC are decreased. The threshold can be signalled or pre-defined.

In another embodiment, when the predictor intensity difference is too large or too small, the blending weightings can be only for the current predictor.

In another embodiment, when the predictor intensity SAD or predictor intensity SSD or predictor intensity SATD is too large or too small, the blending weightings can be only for the current predictor.

In another embodiment, when the predictor intensity difference is too large or too small, the blending lines can be zero or the blending regions can be zero, that is, no blending from neighbouring predictors.

In another embodiment, when the predictor intensity SAD, predictor intensity SSD or predictor intensity SATD is too large or too small, the blending lines can be zero or the blending regions can be zero, that is, no blending from neighbouring predictors.

In another embodiment, when the predictor intensity gradients of the current block for luma or predictor intensity gradients of OBMC predictor for luma is larger or smaller than a threshold, the blending weightings in OBMC are increased. The threshold can be signalled or pre-defined. The threshold can be the number of gradients or the gradient value or histogram of gradients distribution.

In another embodiment, when the predictor intensity gradients of the current block for luma or predictor intensity gradients of OBMC predictor for luma is larger or smaller than a threshold, the blending weightings in OBMC are decreased. The threshold can be signalled or pre-defined. The threshold can be the number of gradients or the gradient value or histogram of gradients distribution.

In another embodiment, when the predictor intensity gradients of the current block for chroma or predictor intensity gradients of OBMC predictor for chroma is larger or smaller than a threshold, the blending weightings in OBMC are increased. The threshold can be signalled or pre-defined. The threshold can be the number of gradients or the gradient value or histogram of gradients distribution.

In another embodiment, when the predictor intensity gradients of the current block for chroma or predictor intensity gradients of OBMC predictor for chroma is larger or smaller than a threshold, the blending weightings in OBMC are decreased. The threshold can be signalled or pre-defined. The threshold can be the number of gradients or the gradient value or histogram of gradients distribution.

In another embodiment, when the predictor intensity gradients of the current block for luma or predictor intensity gradients of OBMC predictor for luma is larger or smaller than a threshold, the blending lines or the blending regions in OBMC are increased. The threshold can be signalled or pre-defined. The threshold can be the number of gradients or the gradient value or histogram of gradients distribution.

In another embodiment, when the predictor intensity gradients of the current block for luma or predictor intensity gradients of OBMC predictor for luma is larger or smaller than a threshold, the blending lines or the blending regions in OBMC are decreased. The threshold can be signalled or pre-defined. The threshold can be the number of gradients or the gradient value or histogram of gradients distribution.

In another embodiment, when the predictor intensity gradients of the current block for chroma or predictor intensity gradients of OBMC predictor for chroma is larger or smaller than a threshold, the blending lines or the blending regions in OBMC are increased. The threshold can be signalled or pre-defined. The threshold can be the number of gradients or the gradient value or histogram of gradients distribution.

In another embodiment, when the predictor intensity gradients of the current block for chroma or predictor intensity gradients of OBMC predictor for chroma is larger or smaller than a threshold, the blending lines or the blending regions in OBMC are decreased. The threshold can be signalled or pre-defined. The threshold can be the number of gradients or the gradient value or histogram of gradients distribution.

In another embodiment, when the number of predictor intensity gradients or the predictor intensity gradient values or histogram of gradients is too large or too small, the blending weightings can be only for the current predictor.

In another embodiment, when the number of predictor intensity gradients or the predictor intensity gradient values or histogram of gradients is too large or too small, the blending lines can be zero or the blending regions can be zero, that is, no blending from neighbouring predictors.

In another embodiment, when the prediction mode of the current block is IBC mode, IntraTMP mode, or non-inter-prediction mode, the blending weighting is increased.

In another embodiment, when the prediction mode of the current block is IBC mode, IntraTMP mode or non-inter-prediction mode, the blending weighting is decreased.

In another embodiment, when the prediction modes of the current block are IBC mode, IntraTMP mode, or non-inter-prediction mode, the blending lines are increased.

In another embodiment, when the prediction mode of the current blocks is IBC mode or IntraTMP mode, non-inter-prediction mode, the blending lines are decreased.

In another embodiment, when prediction modes of neighbouring blocks are IBC modes, IntraTMP modes or non-inter-prediction modes, the blending weighting is increased.

In another embodiment, when prediction modes of neighbouring blocks are IBC modes, IntraTMP modes or non-inter-prediction modes, the blending weighting is decreased.

In another embodiment, when prediction modes of neighbouring blocks are IBC modes, IntraTMP modes or non-inter-prediction modes, the blending lines are increased.

In another embodiment, when prediction modes of neighbouring blocks are IBC modes, IntraTMP modes or non-inter-prediction modes, the blending lines are decreased.

In another embodiment, when the prediction mode of neighbouring blocks is IBC mode, IntraTMP mode or non-inter-prediction mode, the blending weightings can be only for the current predictor.

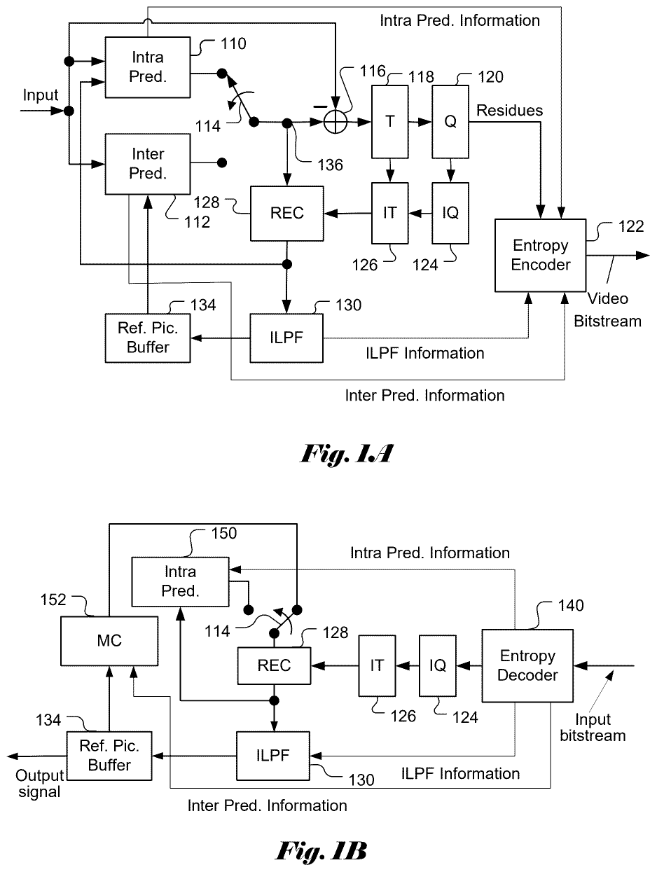

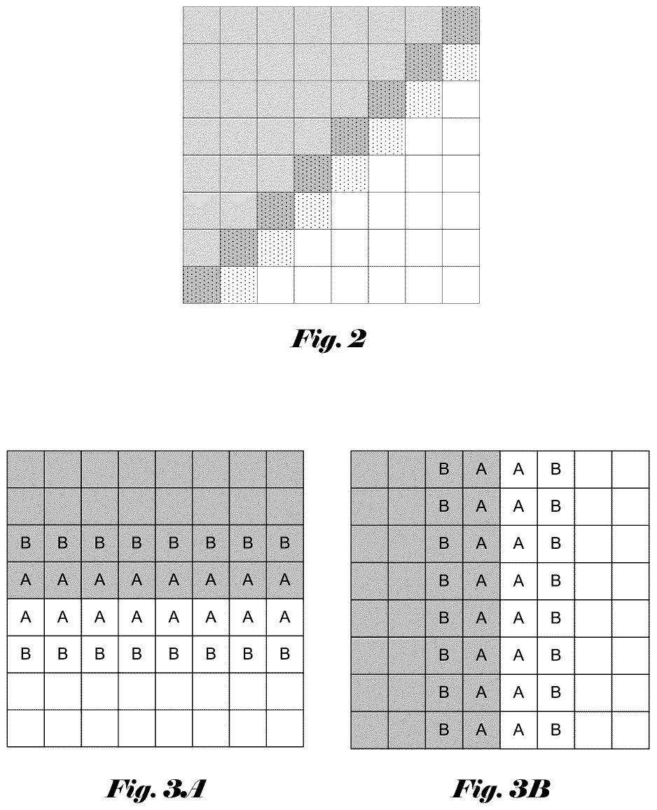

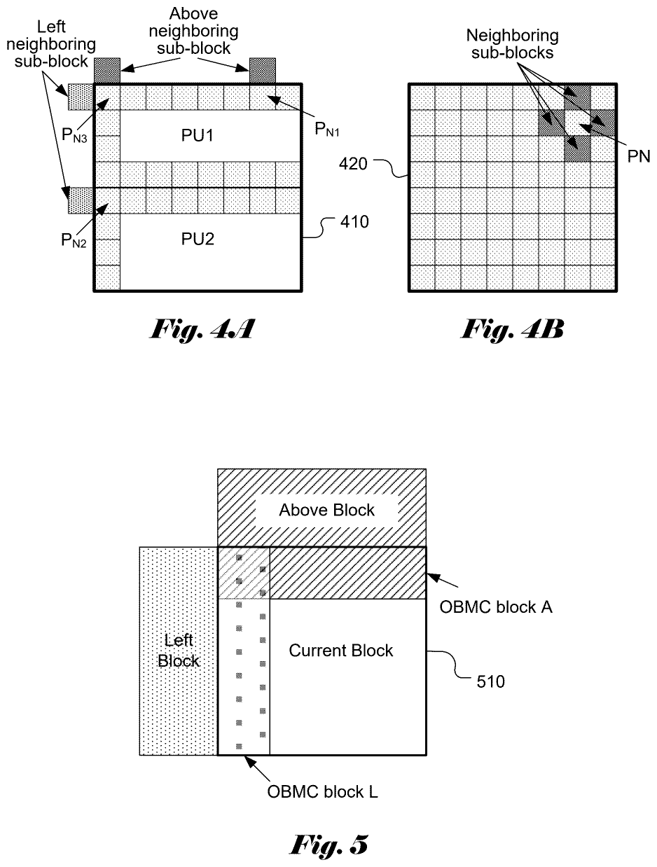

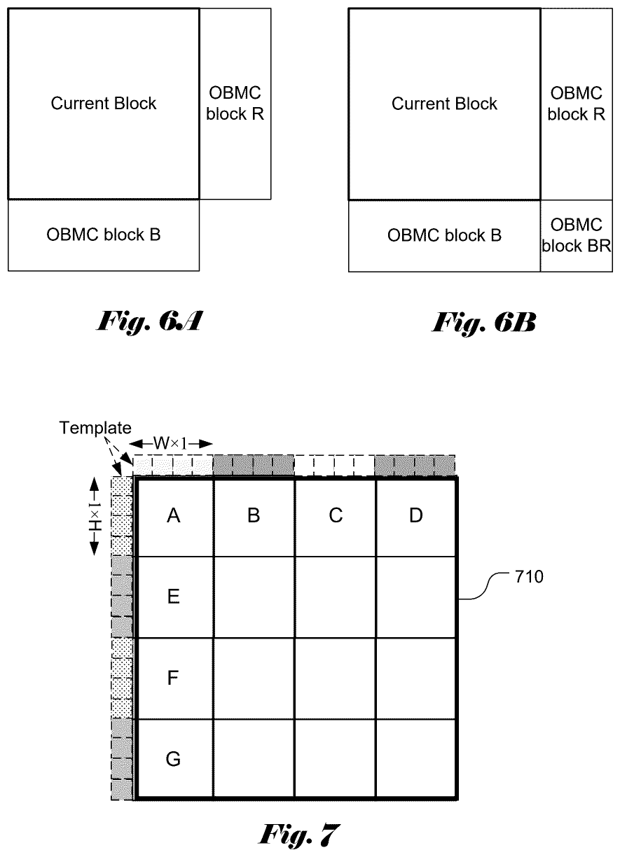

The parameter inheritance for OBMC method as described above can be implemented in an encoder side or a decoder side. For example, any of the proposed methods can be implemented in an Inter and/or Intra prediction modules (e.g. Intra Pred. 150 and/or MC 182 in FIG. 1B) in a decoder or an Inter and/or Intra prediction module in an encoder (e.g. Intra Pred. 110 and/or Inter Pred. 112 in FIG. 1A). Any of the proposed methods can also be implemented as a circuit coupled to the inter/intra coding module at the decoder or the encoder. However, the decoder or encoder may also use additional processing unit to implement the required processing. While the Inter/Intra prediction units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 14 illustrates a flowchart of an exemplary video coding system, where parameters associated with coding tools applied to the current block and/or the neighbouring block are inherited from the current block and/or the neighbouring block during the OBMC process according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data comprising a current block, a current subblock, a neighbouring block, or a neighbouring subblock are received in step 1410. One or more parameters associated with one or more coding tools applied to the neighbouring block, the neighbouring subblock, the current block, the current subblock or a combination thereof are determined in step 1420, wherein at least one of said one or more parameters is inherited from the neighbouring block, the neighbouring subblock, the current block, the current subblock or the combination thereof. OBMC (Overlapped Block Motion Compensation) process is applied to at least one boundary of the current block, the current subblock, the neighbouring block and the neighbouring subblock according to OBMC parameters comprising said at least one of said one or more parameters in step 1430.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data comprising a current block, a current subblock, a neighbouring block, or a neighbouring subblock;
determining one or more parameters associated with one or more coding tools applied to the neighbouring block, the neighbouring subblock, the current block, the current subblock or a combination thereof, wherein at least one of said one or more parameters is inherited from the neighbouring block, the neighbouring subblock, the current block, the current subblock or the combination thereof;
applying OBMC (Overlapped Block Motion Compensation) process to at least one boundary of the current block, the current subblock, the neighbouring block and the neighbouring subblock according to OBMC parameters comprising said at least one of said one or more parameters.

2. The method of claim 1, wherein said one or more coding tools belong to a group comprising LIC (Local Illumination Compensation), BCW (Bi-Prediction with CU-level Weight), BDOF (Bi-Directional Optical Flow), DMVR (Decoder-Side Motion Vector Refinement), GPM (Geometric Partitioning Mode), CIIP (Combined Inter and Intra Prediction), MMVD (Merge Mode with MVD), OOB (Out Of Boundary), AMVP (Advanced Motion Vector Prediction), IBC (Intra Block Copy), or any combination thereof.

3. The method of claim 2, wherein said one or more parameters correspond to one or more LIC parameters, interpolation filter type, BCW index, BDOF type, DMVR type, GPM type, template matching type, CIIP type, MMVD type, MMVD index, OOB type, AMVP-merge type, IBC type, or a combination thereof.

4. The method of claim 2, wherein said at least one of said one or more parameters is inherited from the neighbouring block, the neighbouring subblock, the current block or the current subblock with one or more constraints.

5. The method of claim 4, wherein said one or more constraints comprise CTU constraint, CTU row constraint, CTU column constraint, block characteristics, OOB condition, or a combination thereof.

6. The method of claim 1, wherein said one or more parameters correspond to motion information associated with the neighbouring block, the neighbouring subblock, the current block, the current subblock or the combination thereof.

7. The method of claim 6, wherein the motion information is inherited from the neighbouring block, the neighbouring subblock, the current block or the current subblock with one or more constraints.

8. The method of claim 7, wherein said one or more constraints comprise CTU constraint, CTU row constraint, CTU column constraint, block characteristics, OOB condition, or a combination thereof.

9. The method of claim 6, wherein the motion information comprises MV (Motion Vector), integer MV, affine model, affine motion, control-point MVs, inter-prediction direction, merge index or a combination thereof.

10. An apparatus for video coding, the apparatus comprising one or more electronics or processors arranged to:
receive input data comprising a current block, a current subblock, a neighbouring block, or a neighbouring subblock;
determine one or more parameters associated with one or more coding tools applied to the neighbouring block, the neighbouring subblock, the current block, the current subblock or a combination thereof, wherein at least one of said one or more parameters is inherited from the neighbouring block, the neighbouring subblock, the current block, the current subblock or the combination thereof;
apply OBMC (Overlapped Block Motion Compensation) process to at least one boundary of the current block, the current subblock, the neighbouring block and the neighbouring subblock according to OBMC parameters comprising said at least one of said one or more parameters.
